(19) United States
(12) Patent Application Publication
(10) Pub. No.: US 2004/0250009 A1
(43) Pub. Date: Dec. 9, 2004

(54) Storage device with optimal compression management mechanism

(75) Inventors: Chia-Li Chen, Taipei (TW); Hsiang-An Hsieh, Taipei (TW)

Correspondence Address: TROXELL LAW OFFICE PLLC, SUITE 1404, 5205 LEESBURG PIKE, FALLS CHURCH, VA, 22041, US

(73) Assignee: Carry Computer Eng. Co., Ltd.

(21) Appl. No.: 10/648,201

(22) Filed: Aug. 27, 2003

(30) Foreign Application Priority Data
Jun. 5, 2003 (TW) 092115319

(51) Int. Cl. G06F 12/00

(52) U.S. Cl. 711/103; 711/118

(57) ABSTRACT

The present invention discloses a storage device with optimal compression management mechanism, mainly comprising a controller and at least a solid-state storage medium; where said controller at least has a system interface that may be connected to an external system end, a microprocessor processing system instructions, and a memory interface communicating with said solid-state storage medium; said controller detects and distinguishes the type of raw data to be stored, chooses the compression algorithm and associated parameters most suitable for the raw data, and then compresses the raw data into minimized data in the optimal compression ratio and writes the compressed data into said solid-state storage medium; in that way, the storage device may boost the storage capacity of said solid-state storage medium without increasing physical memory of said solid-state storage medium.

### FIELD OF THE INVENTION

The present invention relates to a storage device with optimal compression management mechanism, in particular to a storage device that may choose the most suitable compression algorithm automatically to compress the data to be stored in the optimal way.

### RELATED ART OF THE INVENTION

Currently, solid-state storage media (e.g., flash memory) utilizing silicon wafers as the memory becomes more and more popular. Due to the benefits of silicon waters such as low power consumption, high reliability, high storage capacity, and high access speed, they are widely used in mini memory cards (e.g., CF cards, MS cards, SD cards, MMC cards, and SM cards) and USB U-disks. Besides a solid-state storage medium, such a storage device A (see FIG. 6) has a controller A1 in it. Said controller A1 has a system interface A11 that may be connected to an external system end B, a microprocessor A12 processing system instructions, and a memory interface A13 communicating with the solid-state storage medium A2. Thus said controller A1 may write the data from the system end B into said solid-state storage medium A2 or read data stored in said solid-state storage medium A2.

However, whether for memory cards or for USB portable disks, the production costs and sales prices depend on the capacity of their embedded solid-state storage media, for example, there are 64 MB, 128 MB, and 256 MB storage media currently available, and the cost and sales price are in proportion to the capacity of embedded storage media, i.e., the high the capacity of embedded storage medium is, the higher the price of the storage device is. However, as the hardware manufacturing technology develops to a certain degree, solid-state storage media have encountered the same embarrassment as today's CD-R disks, i.e., the storage capacity per unit area of silicon wafer can't be increased further. Though the emerging nanometer technologies may further reduce the granularity of storage space to increase the storage capacity, these technologies are in the budding age and still can't be used to overcome above embarrassment. In practice, there is away to solve above problem, i.e., devise another socket at an appropriate position on the body of said storage device (memory card or USB portable disk) to insert an external memory card to expand the storage capacity of the memory device. Though that way may solve the problem of insufficient storage capacity, it requires additional external memory cards, which lead to cost increase.

From another viewpoint, if additional solid-state storage medium or external storage device is to be avoided, necessary compression measures have to be taken for raw data to reduce the storage volume required for the raw data, in order to boost the data storage capacity of existing solid-state storage media. However, data compression can only be done on computers till now. That is to say, on computers, files maybe compressed with appropriate compression software (e.g., Winrar, Winzip, etc.) and then stored in internal storage devices (e.g., hard disk) or external storage devices (e.g., CDs, diskettes, portable disks, or electronic memory cards), in order to save storage space and achieve higher transmission rate.

Therefore, it is urgent task to develop a storage device that delivers not only storage function but also data compression capability to compress raw data before storage. Preferably, such a storage device can also choose the optimal compression algorithm to “minimize” the raw data, in order to boost the storage capacity of existing storage media significantly without adding additional storage medium or external storage devices.

### DESCRIPTION OF THE INVENTION

The main purpose of the invention is to provide a storage device with optimal compression management mechanism, which may boost the data storage capacity of the solid-state storage medium through compressing raw data to reduce data volume significantly with the internal compression mechanism. In that way, the storage device helps to increase data storage capacity, decrease product costs, and improve data access speed.

Another purpose of the invention is to provide a storage device with optimal storage management mechanism, which may choose the optimal compression algorithm automatically to minimize the volume of raw data to boost the data storage capacity of the solid-state storage medium significantly.

To attain above and other purposes and efficacies, the storage device with optimal compression management mechanism mainly comprises a controller and at least a solid-state storage medium, wherein said controller has an internal system interface that may be connected to a system end, a processor that processes system instructions, and a memory interface that communicates said solid-state storage medium. Said controller is featured with: there is a data compression/decompression module between the system interface and the memory interface, and the data compression/decompression module may compress the raw data to be stored at an appropriate compression ratio and then store the compressed data into the solid-state storage medium.

To attain optimal compression effect, said data compression/decompression module has an internal data compression circuit and a plurality of data compression algorithms that are used with said data compression circuit.

Said microprocessor distinguishes the type of raw data transmitted via the system interface and chooses the optimal data compression algorithm, and then instructs the data compression circuit to compress the raw data with said optimal data compression algorithm to minimize data volume and store the compressed data into said solid-state storage medium via the memory interface.

To understand above and other purposes, features, and benefits of the invention better, the invention is described in the following embodiments, with reference to the attached drawings.

### EMBODIMENTS OF THE INVENTION

Please see FIG. 1, a sketch map of the internal circuit of said storage device with optimal compression mechanism. The storage device 1 may be a memory card that may be widely used in various portable digital products or a USB U-disk that may be used in PCs, or a storage device with solid-state storage medium (i.e., Flash Memory) under development.

The storage device 1 comprises a controller 10 and at least a solid-state storage medium 20; said controller 10 comprises a system interface 104, a microprocessor 102, and a memory interface 106. Said system interface 104 may be connected to an external system end 2 (i.e., a portable digital product or a PC); said memory interface 106 communicates with said solid-state storage medium 20; said microprocessor 102 is wired to said system interface 104 and said memory interface 106.

Please see FIG. 1. To boost the storage capacity of the solid-state storage medium, a data compression/decompression module 108 is devised between the system interface 104 and the memory interface 106 in said storage device 1 and is wired to said system interface 104 and said memory interface 106. In addition, to adapt to different transmission speeds of high speed interface and low speed interface, there is the first data cache 110 and the second data cache 120 in the controller; said first data cache 110 is wired to said data compression/decompression module 108 and said system interface 104 and serves as the front-end cache of the data compression/decompression module 108; said second data cache 120 is wired to that data compression/decompression module 108 and said memory interface 106 and serves as the rear-end cache of the data compression/decompression module 108. Said caches 110 and 120 are used to store data temporarily.

When the raw data is to be stored in the solid-state storage medium 20 in said storage device 1, the system interface 104 receives raw data transmitted from the external system end 2, and the microprocessor 102 compresses the raw data at an appropriate compression ratio through the compression mechanism of the data compression/decompression module 108 and then stores the compressed data into said solid-state storage medium via the memory interface 106. Thus the invention enables the solid-state storage medium 20 to store data volume that is multi times of the raw data.

In the present invention, the system interface stores the raw data received in the first data cache 110 before the data is transmitted for compression. Then, the data compression/decompression module 108 retrieves raw data from the first data cache 110 at a certain transmission speed, compresses the raw data, and then transfers the compressed data to the second data cache 120. Under the control of the microprocessor 102, the compressed data in the second data cache 120 is stored in the solid-state storage medium 20 via the memory interface 106.

On the other hand, during decompression, the data compression/decompression module 108 retrieves the compressed data from-the solid-state storage medium 20 via the memory interface 106 and decompresses it. The second data cache 120 stores the compressed data to be decompressed, and the first data cache 110 stores the decompressed data raw data, which is transferred to the external system end 2 via the system interface 104.

Please see FIG. 2, wherein the data transferred from the external system end 2 and stored in the solid-state storage medium 20 comprises not only raw data but also Control Information for the raw data. The solid-state storage medium 20 comprises several data storage blocks 4. In the present embodiment, it is supposed that each data storage block 4 store 528 data bits. Each data storage block 4 comprises a data storage area 42 (occupying 512 data bits, similar to a sector of the hard disk) and a Control Information storage area 44 (occupying 16 bits). The Control Information in the Control Information storage area 44 comprises a Status Flag 441, an Error Correction Code 442, a Logical Address Record 443, and a reserved area as the reserved area 444 shown in FIG. 2. In the optimal compression/decompression process, the present invention utilizes said reserved area 444 to store the compression record.

Please see FIG. 1-FIG. 3, wherein the optimal compression technology used in the present invention is described.

As shown in FIG. 1, the data compression/decompression module 108 has a data compression circuit 1082 and a plurality of algorithm definitions 1083a˜1083n and parameter lists 1084a˜1084n used with said data compression circuit 1082. Each algorithm definition defines a compression/decompression algorithm, which may be used with different parameter lists in order to minimize the data volume of the raw data through combinations of the compression algorithms.

The microprocessor 102 distinguishes the type of the raw data transferred via the system interface 104 to determine the optimal compression combination. The microprocessor 102 distinguishes the type of the raw data through detecting the distribution of binary bits in the raw data, i.e., it determines the optimal algorithm according to the proportion, distribution, and repetition of “0” and “1” bits in raw data. When the data type is distinguished, the microprocessor chooses the most suitable combination between the algorithm definition group 1083 and the parameter list group 1084 and hands it over to the data compression circuit 1082 to compress the raw data into the minimized data volume and store the compressed data into the second data cache 120. As the memory interface 106 is triggered and stores the compressed data in the solid-state storage medium 20, the indexes of the corresponding optimal algorithm definition and parameter list are also stored in the solid-state storage medium 20. Wherein the compressed data is stored in the data storage area 42 in the data storage blocks 4, while the indexes are stored in the reserved area 444 in the data storage blocks 4.

In addition, there is a data decompression circuit 1085 in the data compression/decompression module 1082. When the external system end 2 retrieves data stored in the storage device 1, said data decompression circuit 1085 is triggered by the microprocessor 102 reads the indexes stored in the reserved areas 444 in the solid-state storage media via the memory interface 106 and decompresses the compressed data into raw data according to the algorithm and the parameter list referred by the indexes, and then transfer the raw data to the external system end via the system interface 104.

Please see FIG. 4 and FIG. 5A, the flowcharts of the optimal compression management mechanism used in a preferred embodiment of the invention.

When the raw data transferred from the external system end is loaded into the first data cache 110, the microprocessor 102 detects the distribution of binary bits in the raw data and then chooses the optimal combination between the algorithm definition 1083 and the parameter lists 1084. In the present embodiment, the first algorithm definition 1083a and the second parameter list 1084b is selected to constitute the compression combination (1, 2); next, the data compression circuit 1082 in the data compression/decompression module 108 is triggered and the compression combination (1, 2) is handed over to the compression circuit 1082 as the basis for raw data compression. In the present embodiment, the compression combination (1, 2) indicates to compress the raw data at ½ compression ratio i.e., suppose the raw data occupies 512 bytes, the compressed data will only occupy 256 bytes. Thus the data storage area 42 in a data storage block 4, which can only store a batch of raw data originally, may store 2 batches of compressed data now. Thus the storage capacity of the solid-state storage medium is doubled.

As the compressed data is stored, two indexes (1, 2) are added in the reserved area 444 of the Control Information storage area 44, and the Status Flag 441, Error Correction Code 442, and Logical Address Record 443 maintains constant. The first number and the second number in the parentheses (i.e., (1, 2)) indicate the first algorithm definition and the second parameter list, respectively. Therefore, the indexes (1, 2) may facilitate data decompression.

Please see FIG. 4 and FIG. 5B, the flowcharts of optimal decompression management mechanism used in a preferred embodiment in the present invention.

When the controller receives a data retrieval request from the system end, it locates the logical address of the data according to the Logical Address Record 443 of the data and the corresponding data storage block 4 in the solid-state storage medium, and then read the data stored in the data storage block 4 in the solid-state storage medium to the second data cache 120. Next, the microprocessor triggers the data decompression circuit 1085 to read the index (1, 2) stored in the reserve area 444 in the same data storage block 4. Then the data decompression circuit reads the first algorithm definition and the second parameter and decompresses the compressed data into raw data and transfers the raw data to the first data cache 110. Finally, the raw data in the first data cache 110 is transferred to the external system end 2. In conclusion, the present invention is disclosed as above with preferred embodiments. However, it is noted that above embodiments shall not constitute any limitation to the invention. Any person familiar with the technologies may carry out modifications or embellishments to the embodiments without deviating from the concept and scope of the invention. Therefore, the scope of the invention is solely defined with the attached claims. Any embodiment implemented with equivalent modifications or embellishments to the invention (e.g., replace the microprocessor distinguishing the type of raw data to with a circuit, such as a data compression circuit) shall fall in the scope of the invention.

### DESCRIPTION OF THE DRAWINGS

FIG. 1 is a sketch map of the circuit of a preferred embodiment in the present invention.

FIG. 2 shows the content of the solid-state storage medium in FIG. 1 under uncompressed state.

FIG. 3 is a sketch map of the circuit of another preferred embodiment in the present invention.

FIG. 4 shows the content of the solid-state storage medium in FIG. 3 under compressed state.

FIG. 5A shows the compression process of the embodiment shown in FIG. 3.

FIG. 5B shows the decompression process of the embodiment shown in FIG. 3.

FIG. 6 is a sketch map of a common circuit.

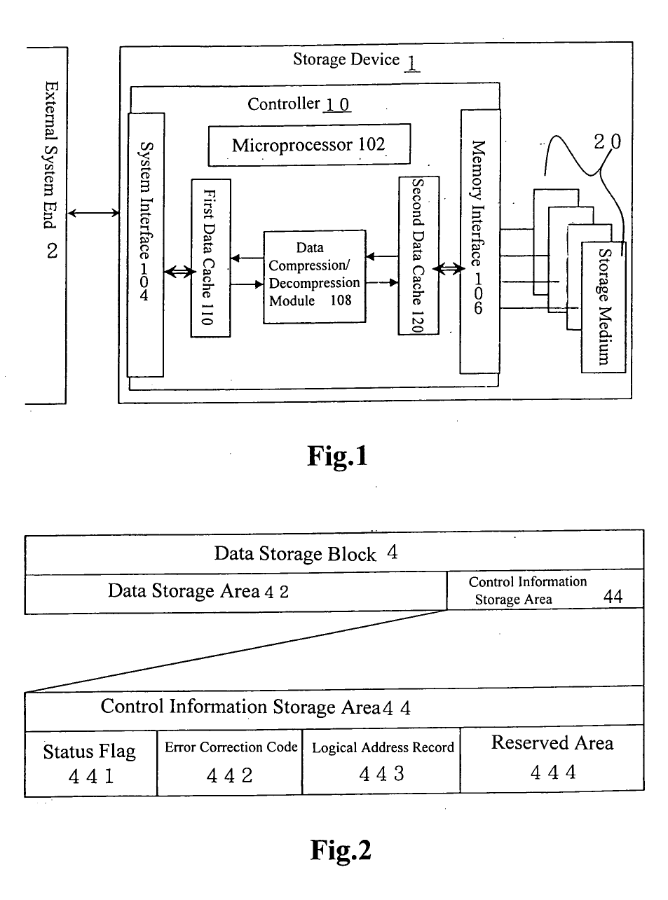

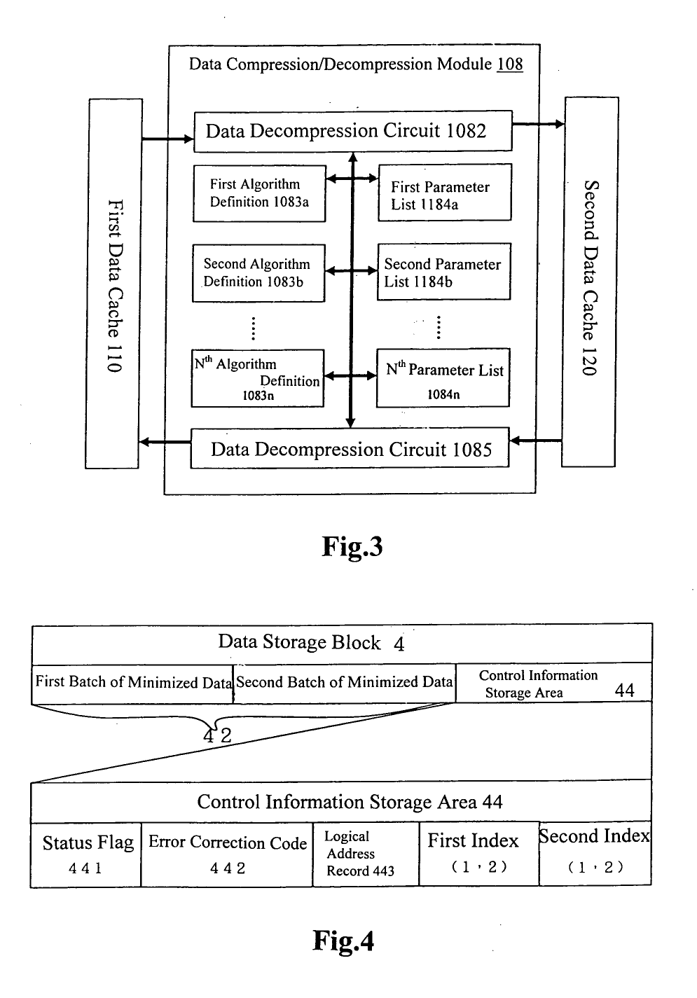

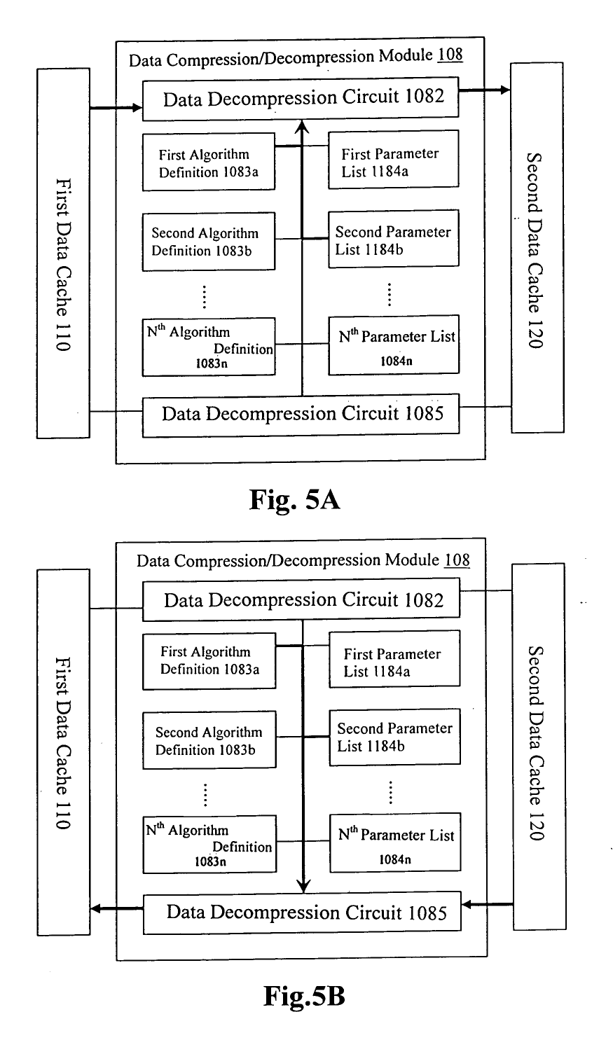

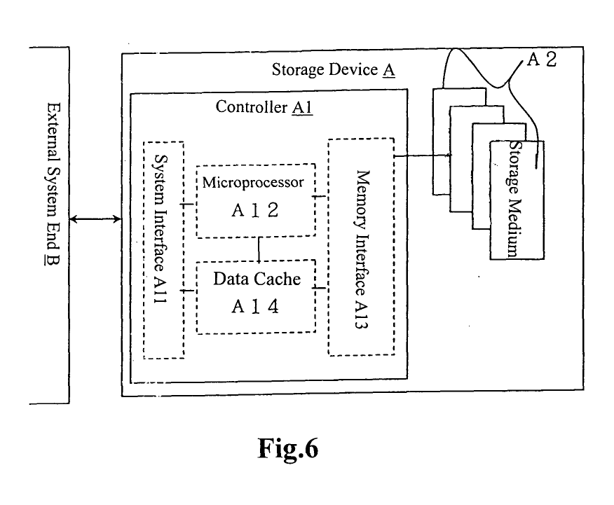

### DESCRIPTION OF SYMBOLS

1: Storage Device

10: Controller

104: System Interface

102: Microprocessor

106: Memory Interface

108: Data Compression/Decompression Module

1082: Data Compression Circuit

1083a˜1083n: Algorithm Definition

1084a˜1084n: Parameter List

1085: Data Decompression Circuit

110: First Data Cache

120: Second Data Cache

20: Solid-State Storage Medium

2: External System End

4: Data Storage Block

42: Data Storage Area

44: Control Information Storage Area

441: Status Flag

442: Error Correction Code

443: Logical Address Record

444: Reserved Area

What is claimed is:

1. A storage device with optimal compression management mechanism, comprising a controller and at least a solid-state storage medium; said controller has an internal system interface that may be connected to an external system end, a microprocessor that processes system instructions, and a memory interface that communicates with said solid-state storage medium; wherein said storage device is featured with:
a data compression/decompression module is devised between said system interface and said memory interface; said data compression/decompression module is wired to said microprocessor and has a data compression circuit and a plurality of algorithm definitions and parameter lists that are used with said data compression circuit;
said microprocessor distinguish the type of the raw data transferred from the system interface and choose the most suitable compression combination from said algorithm definitions and parameters; said data compression circuit compresses the raw data into minimized data volume according said compression combination and stores the compressed data into said solid-state storage medium.

2. The storage device with optimal compression management mechanism as in claim 1, wherein said solid-state storage medium stores indexes referring to the optimal algorithm definition and parameter list.

3. The storage device with optimal compression management mechanism as in claim 2, wherein said data compression/decompression module further has a data decompression circuit, which is triggered by the microprocessor to read said indexes from the solid-state storage medium and decompress the compressed data into raw data according to the algorithm definition and parameter list referred by the indexes.

4. The storage device with optimal compression management mechanism as in claim 1, wherein said storage device has the first data cache wired to said system interface, said microprocessor, and said data compression/decompression module.

5. The storage device with optimal compression management mechanism as in claim 1, wherein said microprocessor has the second data cache wired to said memory interface, said microprocessor, and said data compression/decompression module.

6. The storage device with optimal compression management mechanism as in claim 1, wherein said data compression/decompression module is devised in said controller.

7. The storage device with optimal compression management mechanism as in claim 1, wherein said microprocessor distinguishes the type of the raw data on the basis of the distribution of binary bits in the raw data.
